(19) United States
(12) Patent Application Publication
(10) Pub. No.: US 2026/0241568 A1
(43) Pub. Date: Aug. 20, 2026

(54) INFORMATION PROCESSING METHOD, INFORMATION PROCESSING APPARATUS, WORK APPARATUS MANAGEMENT METHOD, ARTICLE MANUFACTURING METHOD, AND RECORDING MEDIUM

(71) Applicant: CANON KABUSHIKI KAISHA, Tokyo (JP)

(72) Inventor: NOBUHIRO YAMASHIRO, Kanagawa (JP)

(21) Appl. No.: 19/536,502

(22) Filed: Feb. 11, 2026

(30) Foreign Application Priority Data
Feb. 17, 2025 (JP) 2025-023605

(51) Int. Cl. B25J 9/16

(52) U.S. Cl. CPC B25J 9/1679; B25J 9/1664; B25J 9/1666; B25J 9/1694

(57) ABSTRACT

An information processing method is executed by a processing unit. The information processing method includes acquiring first information regarding cumulative fatigue accumulated for each of a plurality of work apparatuses, calculating second information regarding predicted fatigue for each of the plurality of work apparatuses based on the cumulative fatigue and predicted additional fatigue to be accumulated at a scheduled use destination, and determining a work apparatus to be used at the scheduled use destination from among the plurality of work apparatuses based on a plurality of pieces of calculated second information.

### BACKGROUND

### Field of the Technology

The present disclosure relates to an information processing method, an information processing apparatus, a work apparatus management method, an article manufacturing method, and a recording medium.

### Description of the Related Art

For example, there has been proposed a technology for calculating fatigue of a device that is estimated to have been accumulated due to (flight) operation of the device such as an aircraft body of an aircraft (see JP 2020-91188 A). JP 2020-91188 A discloses that a plurality of aircraft are cyclically operated in a plurality of regions to equalize the fatigue among the aircraft bodies.

In addition, for example, a technology in which, for transport robots that autonomously travel to transport an object to be transported, a load for each transport robot is estimated, and a transport robot to be used is determined from among a plurality of robots based on the next scheduled transportation route, has been proposed (see JP 2023-3719 A).

### SUMMARY

According to a first aspect of the present disclosure, an information processing method is executed by a processing unit. The information processing method includes acquiring first information regarding cumulative fatigue accumulated for each of a plurality of work apparatuses, calculating second information regarding predicted fatigue for each of the plurality of work apparatuses based on the cumulative fatigue and predicted additional fatigue to be accumulated at a scheduled use destination, and determining a work apparatus to be used at the scheduled use destination from among the plurality of work apparatuses based on a plurality of pieces of calculated second information.

According to a second aspect of the present disclosure, an information processing apparatus includes a processing unit. The processing unit is configured to acquire first information regarding cumulative fatigue accumulated for each of a plurality of work apparatuses, calculate second information regarding predicted fatigue for each of the plurality of work apparatuses based on the cumulative fatigue and predicted additional fatigue to be accumulated at a scheduled use destination, and determine a work apparatus to be used at the scheduled use destination from among the plurality of work apparatuses based on a plurality of pieces of calculated second information.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram schematically illustrating a robot management system according to a first embodiment.

FIG. 2 is a block diagram illustrating an information processing apparatus according to the first embodiment.

FIG. 3 is a block diagram illustrating a management apparatus according to the first embodiment.

FIG. 4 is a flowchart illustrating a robot selection process according to the first embodiment.

FIG. 5 is a view illustrating a robot operation design display screen according to the first embodiment.

FIG. 6 is a view illustrating a robot addition/editing display screen according to the first embodiment.

FIG. 7 is a view illustrating a predicted fatigue calculation setting display screen according to the first embodiment.

FIG. 8 is a view illustrating a lent robot selection setting display screen according to the first embodiment.

FIG. 9 is a view illustrating a lent robot selection setting display screen according to a second embodiment.

FIG. 10 is a block diagram schematically illustrating a robot management system according to a third embodiment.

### DESCRIPTION OF THE EMBODIMENTS

### First Embodiment

Hereinafter, a first embodiment will be described with reference to the drawings.

### Effects to Be Achieved by First Embodiment

For example, an industrial robot (hereinafter, also simply referred to as a “robot”) is often used on a production line serving as a manufacturing facility for manufacturing an article, and in some cases, an installation place cannot be easily changed once the robot is installed. This is because, for reinstallation, operation design of the robot, confirmation of interference with the surroundings, teaching work, and the like need to be performed again, which requires a lot of labor. For example, a mechanism in which current fatigue is calculated based on actual data acquired by operating a device once, and a next task is allocated as disclosed in JP 2023-3719 A does not accurately predict fatigue for the next task, for example. That is, since changing a task does not involve a significant amount of effort, fatigue dispersion can be achieved by a task following the next task based on the fatigue for the next task. However, in a case where the robot cannot be easily reinstalled, such a method is difficult to apply.

In addition, a service for lending an industrial robot is also considered. In such a lending service, maintenance of a returned robot is usually performed regardless of the degree of wear, and the robot is lent to the next lending destination. However, in a case where the fatigue predicted to be accumulated at the next lending destination (hereinafter, also referred to as a “scheduled lending destination”. Further, the scheduled lending destination is included in scheduled use destinations that are destinations where a work apparatus such as the robot is to be used next) can be accurately known in advance, for example, the robot may be lent after only maintenance of a portion requiring maintenance is performed, which leads to a reduction in maintenance workload at the scheduled lending destination and provides benefits to a business operator. In this manner, shipping after performing maintenance in advance based on the fatigue to be accumulated at the scheduled lending destination enhances accuracy of a maintenance plan at the scheduled lending destination. Then, since the number of times maintenance is performed is reduced, an operating time is increased, which provides benefits to a user of the scheduled lending destination. As described above, even for the robot whose reinstallation is not easy, it is possible to construct a lending scheme that is advantageous for both the business operator and the user by accurately predicting the future fatigue and implementing allocation of the next task.

In the operation of the aircraft as disclosed in JP 2020-91188 A, the next destinations are merely rotated among the aircraft to equalize the fatigue among the aircraft bodies of the aircraft. In particular, the aircraft is operated to an assigned destination regardless of the fatigue. Therefore, it is not always possible to select an aircraft suitable for the next destination. In addition, since the fatigue during flight is greatly affected by weather or the like, it is difficult to predict the future fatigue at an operation design stage. Further, also in the technology disclosed in JP 2023-3719 A, the operation of the transport service is determined in response to a request from a service recipient, and it is not possible to accurately predict which operation the robot is to perform or an extent to which the robot is to perform such an operation at the operation design stage.

On the other hand, most industrial robots are installed on a production line where environmental conditions such as temperature and humidity are controlled, and repeatedly perform the same operation. Therefore, the fatigue of the robot in a certain period can be relatively accurately predicted, and an influence of temperature and humidity can also be assumed in advance.

Therefore, the first embodiment described below is intended to obtain effects of accurately predicting the fatigue of the robot based on operation design information for executing a task at the next scheduled use destination, and selecting a robot most suitable for executing the task from among a plurality of robots. Such effects focus on characteristics of the industrial robot that “an influence from an external factor is kept constant” and that “basically the same operation is repeatedly performed”. Hereinafter, details of the first embodiment for achieving such effects will be described.

### Robot Management System

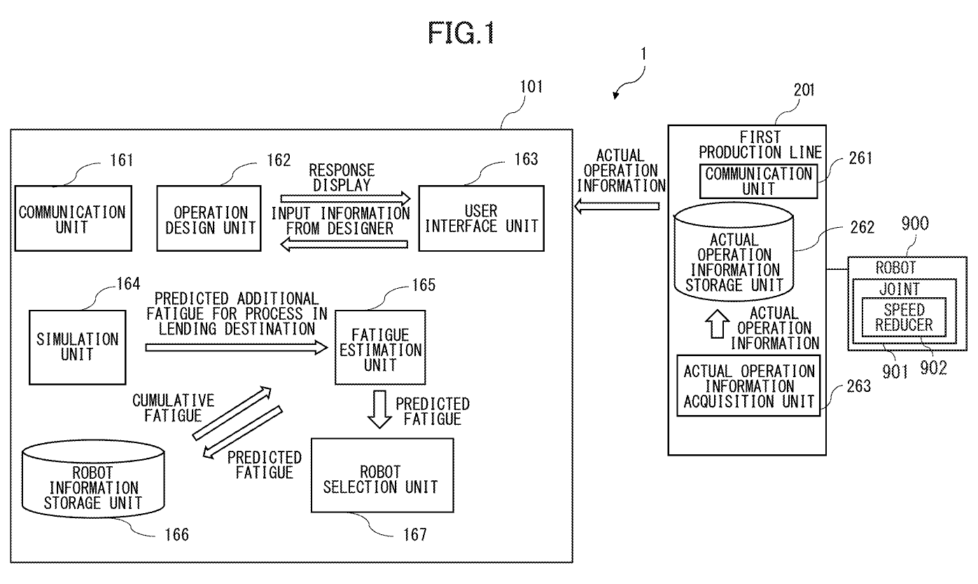

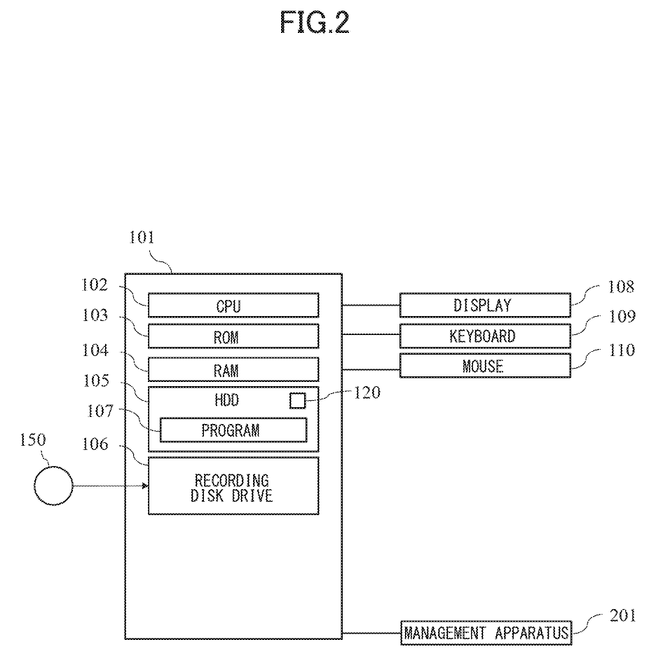

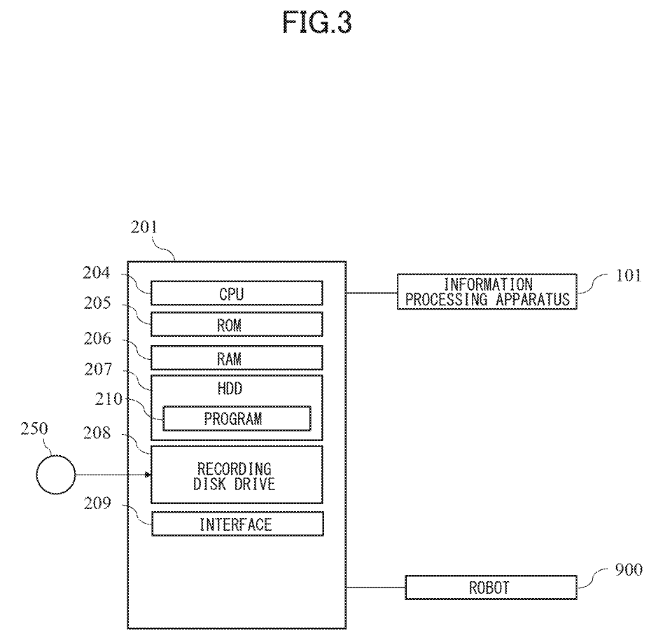

First, an outline of a robot management system serving as a work apparatus management system according to the first embodiment will be described with reference to FIGS. 1 to 3. FIG. 1 is a block diagram schematically illustrating the robot management system according to the first embodiment. FIG. 2 is a block diagram illustrating an information processing apparatus according to the first embodiment. FIG. 3 is a block diagram illustrating a management apparatus according to the first embodiment. FIG. 1 is a block diagram illustrating functions of the information processing apparatus 101, the functions being achieved by a hardware configuration of the information processing apparatus 101 illustrated in FIG. 2. Similarly, FIG. 1 is a block diagram illustrating functions of a management apparatus 201 of a first production line, the functions being achieved by a hardware configuration of the management apparatus 201 illustrated in FIG. 3.

### Configuration of Information Processing Apparatus

First, the hardware configuration of the information processing apparatus 101 of a robot management system 1 will be described with reference to FIG. 2. As illustrated in FIG. 2, the information processing apparatus 101 includes a central processing unit (CPU) 102 which is an example of a processor. The CPU 102 is an example of a processing unit. The information processing apparatus 101 further includes a read only memory (ROM) 103, a random access memory (RAM) 104, and a hard disk drive (HDD) 105 as storage units. The information processing apparatus 101 further includes a recording disk drive 106, a display 108 serving as a display unit which is an input/output interface, and a keyboard 109 and a mouse 110 serving as operation units.

The CPU 102, the ROM 103, the RAM 104, the HDD 105, the recording disk drive 106, the display 108, the keyboard 109, and the mouse 110 are communicably connected to each other via a bus. The ROM 103 stores a basic program related to an operation of a computer. The RAM 104 is a storage device that temporarily stores various types of data such as an arithmetic processing result of the CPU 102. The arithmetic processing result of the CPU 102, various types of data acquired from the outside, and the like are recorded in the HDD 105, and a program 107 for causing the CPU 102 to execute various types of processing is recorded in the HDD 105. The program 107 is application software with which the CPU 102 can execute various types of processing described below. Therefore, the CPU 102 can execute various types of processing described below by executing the program 107 recorded in the HDD 105. In addition, the HDD 105 includes an area serving as a database 120 that records data of various models and the like obtained from execution results of various types of processing described below. The recording disk drive 106 can read various types of data, programs, and the like recorded in a recording disk 150. The database 120 includes a storage area of various types of information of an operation design unit 162, a storage area of a robot information storage unit 166, and the like, which are described in detail below.

In the present embodiment, a non-transitory computer-readable recording medium is the HDD 105, and the program 107 is stored in the HDD 105, but the present technology is not limited thereto. The program 107 may be recorded in any recording medium as long as the recording medium is a non-transitory computer-readable recording medium. For example, a flexible disk, a hard disk, an optical disk, a magneto-optical disk, a magnetic tape, a non-volatile memory, or the like can be used as the recording medium for supplying the program 107 to the computer.

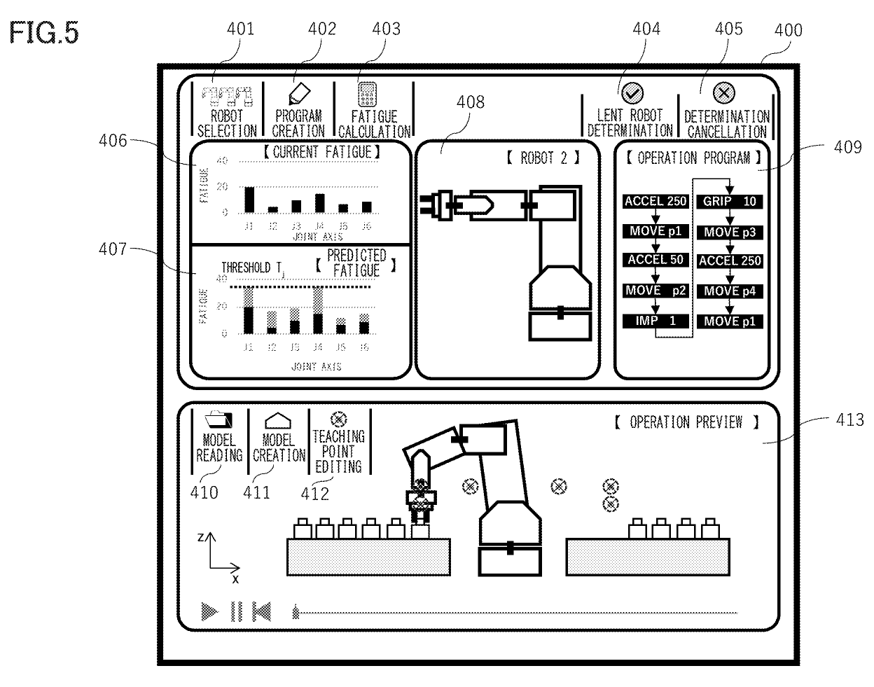

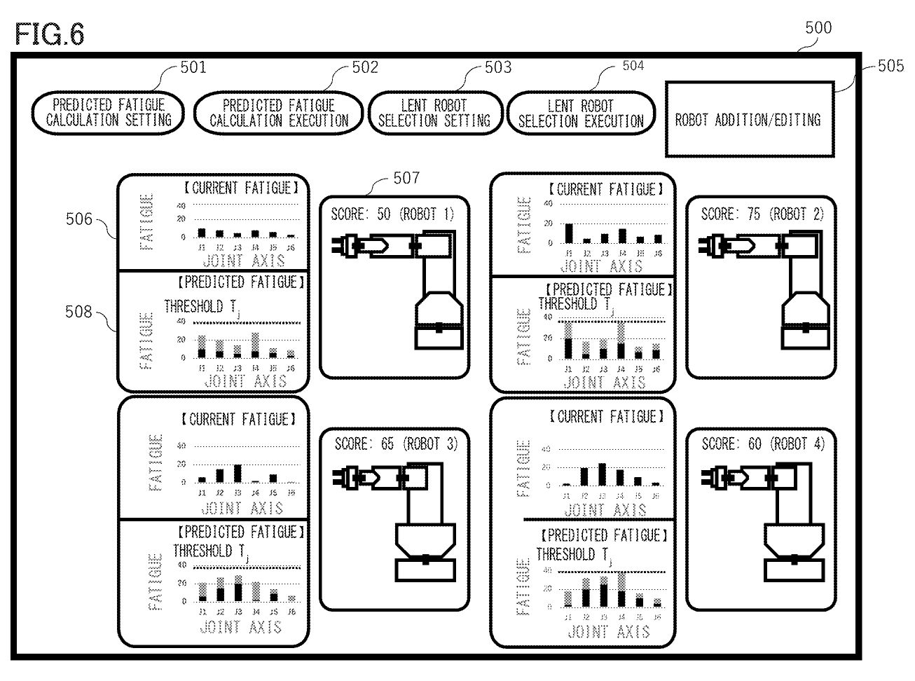

In addition, the management apparatus 201 described in detail below is connected to the information processing apparatus 101. The management apparatus 201 transmits actual operation information of a robot 900 described in detail below to the CPU 102. The robot 900 in the present embodiment is a so-called articulated robot having an articulated arm serving as a manipulator and rotationally or linearly driving each of axes at joints 901 (see FIGS. 5 and 6).

### Configuration of Management Apparatus of First Production Line

Next, the hardware configuration of the management apparatus 201 of the first production line will be described with reference to FIG. 3. The management apparatus 201 includes a CPU 204 which is an example of a processor. The CPU 204 is an example of a control unit. The management apparatus 201 further includes a ROM 205, a RAM 206, and an HDD 207 as storage units. The management apparatus 201 further includes a recording disk drive 208 and an interface 209 which is an input/output interface.

The CPU 204, the ROM 205, the RAM 206, the HDD 207, the recording disk drive 208, and the interface 209 are connected to each other via a bus so as to be able to communicate with each other. The ROM 205 stores a basic program related to an operation of the computer. The RAM 206 is a storage device that temporarily stores various types of data such as an arithmetic processing result of the CPU 204. The arithmetic processing result of the CPU 204, various types of data acquired from the outside, and the like are recorded in the HDD 207, and a program 210 for causing the CPU 204 to execute various types of processing described below is recorded in the HDD 207. The program 210 is application software with which the CPU 204 can execute various types of processing described below. Therefore, the CPU 204 executes control processing by executing the program 210 recorded in the HDD 207, and can control an operation of the manipulator (each joint 901) (not illustrated) of the robot 900. The recording disk drive 208 can read various types of data, programs, and the like recorded in a recording disk 250.

In the present embodiment, a non-transitory computer-readable recording medium is the HDD 207, and the program 210 is stored in the HDD 207, but the present technology is not limited thereto. The program 210 may be recorded in any recording medium as long as the recording medium is a non-transitory computer-readable recording medium. For example, a flexible disk, a hard disk, an optical disk, a magneto-optical disk, a magnetic tape, a non-volatile memory, or the like can be used as the recording medium for supplying the program 210 to the computer.

In the present embodiment, information processing and the control processing are executed by one computer, that is, one CPU, but the present technology is not limited thereto. The information processing and the control processing may be executed by a plurality of computers, that is, the plurality of CPUs 102 and 204.

### Configuration of Robot Management System

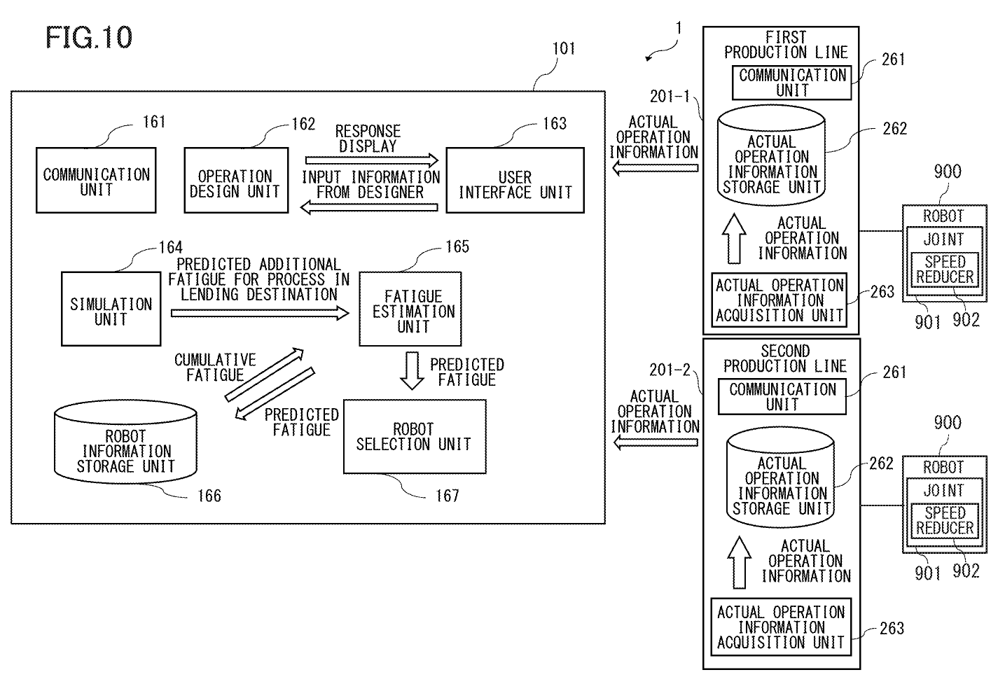

As illustrated in FIG. 1, the robot management system 1 according to the first embodiment includes the information processing apparatus 101, the management apparatus 201 of the first production line, and a plurality of robots 900. The first production line serving as a production facility is a lending destination (a lending destination to which the robot 900 is lent) serving as a use destination of the robot 900, and refers to a production line before the robot 900 is returned in the present embodiment. In addition, a second production line (see FIG. 10) serving as a production facility not illustrated in FIG. 1 indicates a scheduled lending destination serving as a scheduled use destination to which the robot 900 returned from the first production line is scheduled to be lent next, that is, a production line of the scheduled lending destination of the robot 900. Furthermore, the robot 900 is a so-called industrial robot (see, for example, FIGS. 5 and 6), and is implemented by, for example, a six-axis articulated robot in which each joint 901 includes a motor and a speed reducer (e.g. reduction gear) 902 serving as a mechanism unit that reduces a rotational speed of the motor.

The management apparatus 201 includes a communication unit 261 implemented by the interface 209 (see FIG. 3), and the communication unit 261 is configured to be able to communicate with the plurality of robots 900 and the information processing apparatus 101 on the first production line. In addition, the management apparatus 201 includes an actual operation information storage unit 262 and an actual operation information acquisition unit 263.

The actual operation information acquisition unit 263 acquires the actual operation information which indicates values of various devices and sensors included in the first production line. The actual operation information corresponds to, for example, a temperature and a humidity, a motor rotation speed of each joint 901 per operation cycle of the robot 900, an apparatus operation rate, and a takt time, and includes all of pieces of information obtained during operation in addition to the above items. The actual operation information acquisition unit 263 transmits the actual operation information acquired from the first production line to the actual operation information storage unit 262 to store the actual operation information in the actual operation information storage unit 262. The actual operation information storage unit 262 generally plays a role similar to that of a log server or a manufacturing execution system (MES) for operation management or the like. The actual operation information collected in this manner is transmitted to the information processing apparatus 101 via the communication unit 261.

The information processing apparatus 101 includes a communication unit 161, the operation design unit 162, and a user interface unit 163 that function by the above-described hardware configuration. The information processing apparatus 101 further includes a simulation unit 164, a fatigue estimation unit 165, the robot information storage unit 166, and a robot selection unit 167 that function by the above-described hardware configuration.

For example, a designer who is a user designs the operation of the robot 900 by using the information processing apparatus 101, that is, generates an operation program serving as operation setting information for setting the operation of the robot 900 on the production line. The operation program described herein can be designed to be used in any production line. In particular, in the present embodiment, an operation program for the scheduled lending destination (that is, the second production line) to which the robot 900 is to be lent is generated.

That is, the designer inputs the operation design information for designing and setting the operation program for the robot 900 to the information processing apparatus 101 via the user interface unit 163 (the keyboard 109 and the mouse 110). The input operation design information is processed and acquired by the operation design unit 162 (CPU 102) having a CAD modeling function, a robot operation program creation function, and the like, and the operation program is generated according to such pieces of information. A response of the operation design unit 162 is displayed to the designer via the user interface unit 163 (display 108).

That is, the operation design information for designing the operation program for the robot 900 in the scheduled lending destination is input by the designer to the operation design unit 162. Here, the operation design information includes a 3D model and an internal structure of the robot 900, a 3D model and a device configuration of the production line, an already generated operation program for the robot 900, and the like. Furthermore, the operation design information also includes an operation speed and an acceleration of each unit in the robot 900, an end effector weight, the motor rotation speed, an operation takt time, an operation cycle number, the operation rate, a lending period to a lending destination (scheduled lending destination), and environmental information such as a temperature and a humidity of an operation site.

Not all the above items need to be included in the operation design information, but all the pieces of information clarified at the operation design stage for the robot 900 are included in the operation design information. Furthermore, the operation design information also includes information that becomes apparent by combining the above items. For example, such information corresponds to the motor rotation speed of each joint 901 per robot operation cycle, which becomes apparent by combining the internal structure, the already designed operation program, the speed, and the acceleration of the robot 900. The information that becomes apparent by the combination is displayed to the designer via the user interface unit 163 (display 108).

The functions of the operation design unit 162 are not limited to the CAD modeling function and the robot operation program creation function described above. For example, the operation design unit 162 may have functions of general CAD software or simulation software, such as a structure analysis function and an operation preview function.

The robot information storage unit 166 stores and accumulates information input to the information processing apparatus 101. That is, the robot information storage unit 166 accumulates all the pieces of information that have become apparent at the operation design stage for the robot 900, such as the internal structure, the designed operation program, the speed, the acceleration, the lending period to the scheduled lending destination, the takt time, the operation rate of the industrial robot, and the like. In addition, the actual operation information transmitted from the management apparatus 201 is also stored and accumulated in the robot information storage unit 166. The actual operation information includes information when the robot 900 is operated, and the fatigue is cumulatively added based on such information, so that the actual operation information can be stored as first information (hereinafter, simply referred to as “cumulative fatigue”) regarding the current cumulative fatigue accumulated in the robot 900. Since the robot 900 is an articulated robot including a plurality of joints 901 each including the speed reducer 902, the cumulative fatigue is managed for each of the plurality of joints of each robot 900 in the information processing apparatus 101. In addition, it is assumed that the cumulative fatigue includes a value of 0. That is, the robot 900 that has not yet been lent may be managed with the cumulative fatigue set to 0. In this case, the robot 900 to be lent to the scheduled lending destination may be selected by using predicted additional fatigue described below as predicted fatigue.

The simulation unit 164 calculates second information (hereinafter, simply referred to as the “predicted additional fatigue”) regarding the predicted additional fatigue for a process in the scheduled lending destination by using the information in the robot information storage unit 166. Here, the predicted additional fatigue for the process in the scheduled lending destination means fatigue that is predicted to be accumulated in the robot 900 during the lending period to the scheduled lending destination in addition to the current cumulative fatigue accumulated in the robot 900. The predicted additional fatigue can be obtained, for example, by multiplying an operation cycle number during the lending period by the motor rotation speed of each joint 901 per operation cycle. The predicted additional fatigue is also managed for each of the plurality of joints of each robot 900 in the information processing apparatus 101.

The fatigue estimation unit 165 calculates future predicted fatigue of the robot 900 based on the predicted additional fatigue for the process in the scheduled lending destination, which is calculated by the simulation unit 164, and the cumulative fatigue of the robot 900 accumulated in the robot information storage unit 166. The future predicted fatigue of the robot 900 represents, for example, fatigue accumulated in the robot 900 at the end of the lending period to the scheduled lending destination. That is, the future predicted fatigue of the robot 900 can be obtained by adding the predicted additional fatigue for the process in the scheduled lending destination, which is calculated by the simulation unit 164, and the cumulative fatigue of the robot 900 accumulated in the robot information storage unit 166. However, the calculation method is not limited thereto, and can be freely designed as appropriate by the designer. The calculation of the future predicted fatigue of the robot is performed for all of the plurality of robots 900 that are available lending candidates. Furthermore, the predicted fatigue is also managed for each of the plurality of joints of each robot 900 in the information processing apparatus 101.

The predicted fatigue of the plurality of robots 900 calculated by the fatigue estimation unit 165 is output to the robot information storage unit 166 and the robot selection unit 167. The robot information storage unit 166 to which information regarding the predicted fatigue has been input overwrites and updates the cumulative fatigue with the predicted fatigue for the robot 900 selected and determined to be lent to the scheduled lending destination. Such update is performed at a timing when it is determined that the robot 900 is to be lent.

The robot selection unit 167 determines and selects, based on the predicted fatigue input from the fatigue estimation unit 165, a robot 900 that is most suitable as a robot to be lent from among the plurality of robots 900 that are currently available lending candidates. Logic for determining the most suitable robot 900 can be input by the designer via the user interface unit 163. In the present embodiment, for example, determination processing, in which a difference between the predicted fatigue of each joint 901 of the robot 900 and a threshold set for each joint 901 is calculated, and the robot 900 in which a total value of the differences for the respective joints 901 is the smallest is determined as the robot 900 to be lent, can be input. The robot selection unit 167 notifies the designer of a result of determination of the robot 900 that is most suitable as the robot 900 to be lent via the user interface unit 163 (display 108).

A selection method of selecting the robot 900 that is most suitable as the robot 900 to be lent may be selected by the designer from among a plurality of selection methods implemented in advance in the system, or may be freely programmed by the designer. The present technology is not limited thereto, and any method may be used as long as the purpose of determining the robot 900 to be lent from among the plurality of possessed robots 900 can be achieved.

### Robot Selection Process

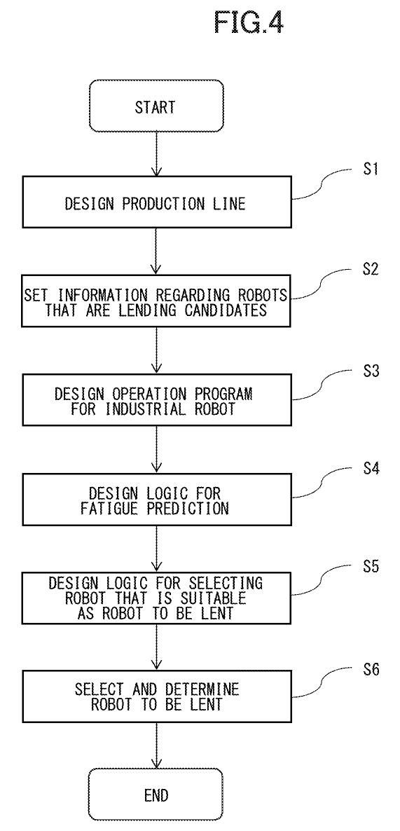

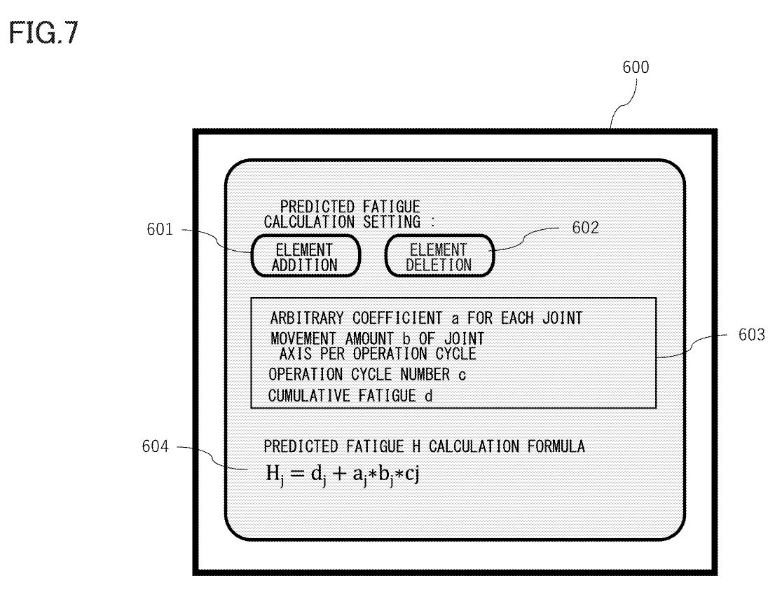

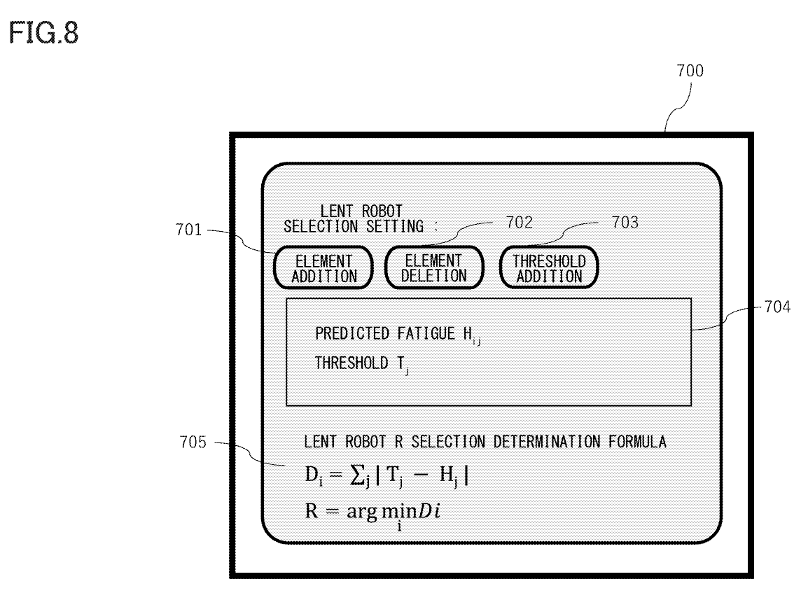

Next, a robot selection process of selecting the robot 900 that is most suitable for lending to the scheduled lending destination in the robot management system 1 will be described with reference to FIGS. 4 to 8. FIG. 4 is a flowchart illustrating the robot selection process according to the first embodiment. FIG. 5 is a view illustrating a robot operation design display screen according to the first embodiment. FIG. 6 is a view illustrating a robot addition/editing display screen according to the first embodiment. FIG. 7 is a view illustrating a predicted fatigue calculation setting display screen according to the first embodiment. FIG. 8 is a view illustrating a lent robot selection setting display screen according to the first embodiment. FIG. 2 illustrates the robot selection process executed by the CPU 102 of the information processing apparatus 101, which can also be said to be a workflow of the designer since the process is illustrated along a process executed by the designer. Furthermore, the display screens illustrated in FIGS. 5 to 8 can also be referred to as user interface screens through which the designer performs setting, editing, addition, determination, and the like.

First, the CPU 102 of the information processing apparatus 101 designs the production line in which the robot 900 to be lent is to be operated based on an operation input from the designer (S1). Specifically, the designer operates a robot selection button 401 on a robot operation design display screen 400 illustrated in FIG. 5 and operates a model creation button 411 to generate a model of the robot 900 or a peripheral object (a component, a table, or the like) on a virtual space. Then, by operating the model, simulation of an actual production operation such as confirmation of interference between the robot 900 and the peripheral object is performed. The model generation and simulation can be confirmed in an operation preview display area 413. In a case where it is determined that the confirmation of the interference between the robot and the peripheral object and the simulation of the production operation are unnecessary, this process does not have to be performed.

Next, the CPU 102 of the information processing apparatus 101 sets information (that is, the operation design information) regarding the plurality of robots 900 that are the lending candidates based on an operation input of the designer (S2). Specifically, the designer operates a robot addition/editing button 505 on a robot addition/editing display screen 500 illustrated in FIG. 6 to input and set the information regarding the plurality of robots 900 that are the lending candidates. Here, the information regarding the plurality of robots 900 that are the lending candidates is not particularly limited, and includes any information regarding the industrial robot, such as a 3D model, an internal structure, a model type, a serial number, a usage history, a maintenance history, and cumulative fatigue of the industrial robot. The input information regarding the plurality of robots that are the lending candidates is held in the robot information storage unit 166 in a state in which it can be determined to which robot each piece of information corresponds. At this time, information that becomes apparent by combining the pieces of input information regarding the robot is also held together.

Subsequently, the CPU 102 of the information processing apparatus 101 designs the operation program for each of the plurality of robots 900 by using the information set in step S2 based on an operation input from the designer (S3). Specifically, for example, the designer operates a robot selection button 402 on the robot operation design display screen 400 illustrated in FIG. 5 to select one of the plurality of robots 900. The selected robot 900 is displayed in a selected robot display area 408, and the operation program for the robot 900 is displayed in an operation program display area 409. In other words, the CPU 102 displays, on the display 108, a screen (operation program display area 409) for previewing work (that is, the operation program) to be executed by a certain robot 900 (certain work apparatus) among the plurality of robots 900 at the scheduled lending destination (second production line). Then, the designer operates a teaching point editing button 412 in the operation preview display area 413 to design the operation program for the selected robot 900. The display in the operation program display area 409 may be described in robot language or visual language, and is not particularly limited.

The CPU 102 collectively displays, on the display 108, an image (selected robot display area 408) corresponding to the certain robot 900 among the plurality of robots 900, the cumulative fatigue (current fatigue display area 406) and the predicted fatigue (predicted fatigue display area 407) of the certain robot 900, the program (operation program) of the work to be performed by the certain robot 900 on the second production line, and the screen (operation preview display area 413) for previewing the work to be performed by the certain robot 900 on the second production line, in the robot operation design display screen 400.

Next, the CPU 102 of the information processing apparatus 101 designs logic for performing fatigue prediction while using the information set so far based on an operation input from the designer (S4). Specifically, for example, when the designer presses a fatigue calculation element setting button 501 on the robot addition/editing display screen 500 illustrated in FIG. 6, a screen transition to a predicted fatigue calculation setting display screen 600 illustrated in FIG. 7 is made. The designer can freely design an element and a calculation formula for fatigue calculation on the predicted fatigue calculation setting display screen 600. That is, the designer can arbitrarily read information of each item from the information stored in the robot information storage unit 166 by operating an element addition button 601 on the predicted fatigue calculation setting display screen 600, and a list of the read items is displayed in a list display area 603. The designer can also delete unnecessary items from the read items by operating an element deletion button 602. The designer can freely design a predicted fatigue calculation formula by using such read elements, and can display the predicted fatigue calculation formula in a calculation formula display area 604. The predicted fatigue calculation formula can use four arithmetic operations, general functions, or custom functions, or the like, but is not particularly limited thereto.

The designer can design the predicted fatigue calculation formula as follows, for example. First, the designer adds an arbitrary coefficient a to each joint 901 of the robot 900 that is the lending candidate. Here, the arbitrary coefficient a means a parameter that the designer desires to variably add for each joint 901, such as a value based on the end effector weight or a strength of each joint 901. Here, the arbitrary coefficient a is used for simplification of the calculation formula. However, a parameter stored in the robot information storage unit 166 may be used, and the number and type to be used are not limited. Next, the designer calculates a movement amount b of each joint 901 per operation cycle. The movement amount b of each joint 901 per operation cycle can be calculated based on a structure of the joint 901 of the robot 900 and the operation program (an operation instruction, a teaching point, the speed, and the acceleration). Further, the designer defines the operation cycle number c during the lending period. Here, the operation cycle number c during the lending period can be calculated based on information regarding the apparatus takt time, the operation rate, and the lending period. The movement amount b of each joint 901 per operation cycle and the operation cycle number c during the lending period are pieces of information that become apparent by combining the pieces of input information regarding the robot 900. For example, in a case where such values are stored in the robot information storage unit 166, it is sufficient if the values are read, and otherwise, the values may be obtained by describing the calculation formula in the work. Finally, the designer defines, as a calculation formula for predicted fatigue H, a formula for multiplying the arbitrary coefficient a by the movement amount b of each joint 901 per operation cycle and the operation cycle number c during the lending period, and adding the multiplied value to cumulative fatigue d. A subscript “j” of the calculation formula for the predicted fatigue H displayed in the calculation formula display area 604 indicates a joint number of the robot 900.

After performing the predicted fatigue calculation setting as described above, the designer presses a predicted fatigue calculation execution button 502 on the robot addition/editing display screen 500 illustrated in FIG. 6 to predict the future fatigue of each of the plurality of available robots 900. Then, the current fatigue and the predicted fatigue are stored in the robot information storage unit 166, respectively displayed in a current fatigue display area 506 and a predicted fatigue display area 508, and reported to the designer.

Next, the CPU 102 of the information processing apparatus 101 designs logic for selecting the robot 900 that is suitable as the robot 900 to be lent to the scheduled lending destination based on an operation input from the designer (S5). The logic for selecting the robot 900 that is suitable as the robot 900 to be lent may be selected by the designer from among a plurality of selection methods implemented in advance in the system, or may be freely programmed by the designer. Here, an example of the latter method in which the logic is freely programmed will be described.

Specifically, for example, when the designer presses a lent robot selection setting button 503 on the robot addition/editing display screen 500 illustrated in FIG. 6, a screen transition to a lent robot selection setting display screen 700 illustrated in FIG. 8 is made. The designer can freely design an element and a lent robot selection determination formula for lent robot selection on the lent robot selection setting display screen 700. That is, the designer can arbitrarily read each item from the information stored in the robot information storage unit 166 by operating an element addition button 701, and a list of the read items is displayed in a list display area 704. The designer can also delete unnecessary items from the read items by operating an element deletion button 702. Furthermore, the designer can add an arbitrary threshold as the element by pressing a threshold addition button 703. The designer can freely design the lent robot selection determination formula by using such read elements, and can display the lent robot selection determination formula in a calculation formula display area 705. The lent robot selection determination formula can use four arithmetic operations, general functions, custom functions, or the like, but is not particularly limited thereto.

The designer can design the lent robot selection determination formula as follows, for example. First, the designer operates the element addition button 701 to read predicted fatigue Hᵢⱼ from the robot information storage unit 166. Next, the designer operates the threshold addition button 703 to register a threshold Tⱼ for the fatigue of each joint 901 determined to require maintenance. Here, a subscript “j” in the predicted fatigue Hᵢⱼ and the threshold Tⱼ represents a joint number of the available robot 900, and a subscript “i” in the predicted fatigue Hᵢⱼ represents a serial number of the available robot 900. Such expression is used for simplification of the formula, but any expression can be used as long as contents of the displayed information can be understood. Here, a difference between the predicted fatigue Hᵢⱼ and the threshold Tⱼ of each joint 901 is obtained, and a total value Dᵢ of the differences for each joint 901 is calculated for each robot. Then, a calculation formula for setting the robot 900 having the smallest total value Dᵢ as the robot 900 to be lent (lent robot R) is defined as the lent robot selection determination formula.

After performing the lent robot selection setting as described above, the CPU 102 of the information processing apparatus 101 selects and determines the robot 900 that is most suitable for lending from among the plurality of available robots 900 based on an operation input from the designer (S6). Specifically, when the designer operates a lent robot selection execution button 504 on the robot addition/editing display screen 500 illustrated in FIG. 6, the robot 900 that is most suitable for lending is selected from among the plurality of available robots 900. Then, the designer is notified of the selected robot 900. Specifically, for “robots 1 to 4” illustrated in FIG. 6, a score is calculated and displayed in a score display area 507 based on the total value Dᵢ (see the predicted fatigue display area 508) of the differences between the predicted fatigue Hᵢⱼ of the respective joints 901 and the threshold Tⱼ. That is, the images corresponding to the plurality of robots 900, the cumulative fatigue (current fatigue: display area 506) of the plurality of robots 900, and the predicted fatigue (display area 508) are displayed on the display 108 in association with each other. Then, the robot having the best score is selected and displayed in the selected robot display area 408 on the robot operation design display screen 400 illustrated in FIG. 5 (“robot 2” is displayed in FIG. 5). In the present embodiment, as an example, a method of giving a score to each robot 900 and notifying the designer of the score has been described. However, any method may be used as long as the robot 900 that is most suitable as the robot 900 to be lent can be determined.

Then, the designer confirms a result on the robot operation design display screen 400 illustrated in FIG. 5, and operates a lent robot determination button 404 in a state in which the robot 900 to be lent is selected to thereby determine the robot 900 to be lent.

### Summary of First Embodiment

As described above, in an information processing method of the information processing apparatus 101 in the robot management system 1 according to the first embodiment, first, the CPU 102 acquires the cumulative fatigue accumulated in the plurality of robots 900 at the lending destination (first production line). Specifically, for example, the cumulative fatigue is calculated based on the actual operation information acquired from the management apparatus 201 of the first production line (see S2). That is, the CPU 102 acquires the current fatigue of the plurality of robots 900.

Subsequently, the CPU 102 calculates information regarding the predicted additional fatigue to be accumulated at the scheduled lending destination (second production line) for the plurality of robots 900. Specifically, the predicted additional fatigue is calculated (simulated) using fatigue prediction logic by the simulation unit 164 based on the operation program (see S3) for the process in the scheduled lending destination, which is designed by the operation design unit 162 (see S4). Furthermore, when calculating the predicted additional fatigue, the CPU 102 calculates the fatigue of each joint 901 (particularly, the speed reducer 902 in each joint 901) of the robot 900 that is an articulated robot. That is, since the CPU 102 calculates fatigue of a portion of the robot 900, which has the lowest durability, durability calculation accuracy can be improved.

Then, the CPU 102 determines and selects the robot 900 to be used in the scheduled lending destination from among the plurality of robots 900 based on the cumulative fatigue and the predicted additional fatigue. Specifically, the CPU 102 calculates the predicted fatigue Hᵢⱼ by adding the predicted additional fatigue to the acquired cumulative fatigue for the plurality of available robots 900, and determines and selects the robot 900 having the smallest difference between the predicted fatigue Hᵢⱼ and the threshold Tⱼ (see S5 and S6).

As a result, it is possible to accurately determine the robot 900 that is suitable for use in the scheduled lending destination (second production line). In particular, by generating the operation program for determining the operation of the robot 900 at the scheduled lending destination and performing simulation based on the operation program, it is possible to accurately calculate the predicted additional fatigue to be accumulated at the scheduled lending destination and to accurately determine the robot to be selected.

Furthermore, the CPU 102 determines and selects the robot 900 having the smallest difference between the predicted fatigue Hᵢⱼ and the threshold Tⱼ, so that it is possible to select the robot 900 having a minimum level of durability required for use at the scheduled lending destination (second production line). As a result, it is possible to keep the robot 900 with low cumulative fatigue available, and for example, in a case where there is another scheduled lending destination for which the predicted additional fatigue is high, it is possible to lend the robot 900 with low cumulative fatigue. For this reason, for example, it is possible to prevent a situation where the robot 900 having remaining capacity is lent first and there is no robot 900 that can be lent to another scheduled lending destination, that is, it is possible to lend the plurality of robots 900 without waste.

In the first embodiment described above, it has been described as an example that the plurality of robots 900 are lent to other business operators, but the present technology is not limited thereto. For example, the use destination does not have to be another business operator and the most suitable robots 900 may be deployed to a plurality of production lines in the same business operator (within an own company), that is, the ownership of the robot 900 may belong to any business operator.

### Second Embodiment

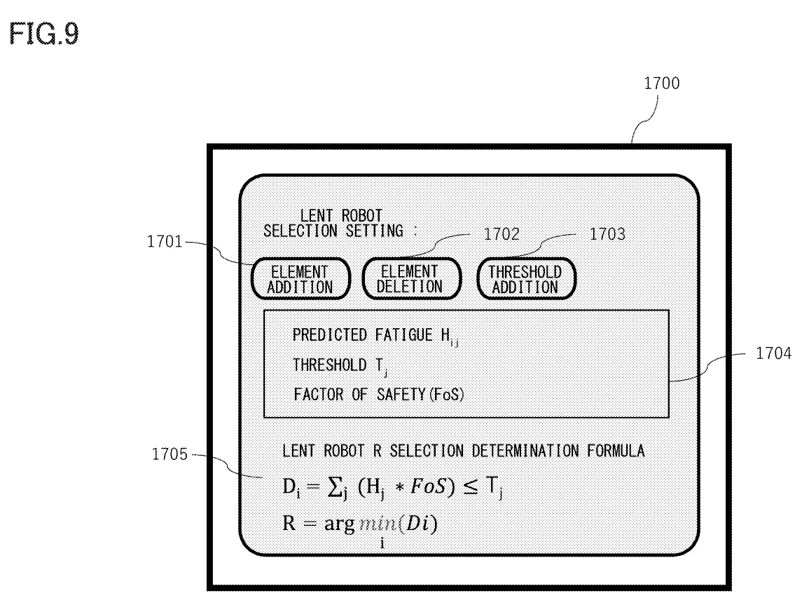

Next, a second embodiment partially modified from the first embodiment will be described with reference to FIG. 9. FIG. 9 is a view illustrating a lent robot selection setting display screen according to the second embodiment. In the description of the second embodiment, the same reference numerals are used for the same parts as those of the first embodiment, and a description thereof will be omitted.

In the first embodiment described above, a robot 900 having a small difference between predicted fatigue Hᵢⱼ and a threshold Tⱼ is selected. This means that the robot 900 having a minimum level of durability required for use at a scheduled lending destination is selected, and, there is no margin in a case where an operating time or a production plan is changed, for example. Therefore, actual fatigue of the lent robot 900 becomes higher than the predicted fatigue, and maintenance is required during a lending period, which may cause a temporary stop of a production line. In the second embodiment, in order to solve such a problem, the robot 900 is selected based on a factor of safety.

Specifically, in a case where a CPU 102 of an information processing apparatus 101 designs logic for selecting the robot 900 that is suitable as the robot 900 to be lent to the scheduled lending destination based on an operation input from a designer (S5), the factor of safety is set in a lent robot selection determination formula. Specifically, the designer can arbitrarily read each item from information stored in a robot information storage unit 166 by operating an element addition button 1701 on a lent robot selection setting display screen 1700 illustrated in FIG. 9. Then, a list of the read items is displayed in a list display area 1704. The designer can also delete unnecessary items from the read items by operating an element deletion button 1702. Furthermore, the designer can add an arbitrary threshold as the element by pressing a threshold addition button 1703.

When designing a lent robot selection determination formula by using such read elements, the designer adds a factor of safety (FoS) as displayed in a calculation formula display area 1705. That is, the factor of safety (FoS) is a coefficient multiplied by predicted fatigue Hⱼ, and “Hⱼ × FoS” can be defined as predicted safety-adjusted fatigue. Then, by setting “Hⱼ × FoS ≤ Tⱼ” as a formula on a condition that the predicted safety-adjusted fatigue is lower than the threshold Tⱼ for fatigue requiring maintenance in the lent robot selection determination formula, a possibility that the maintenance is required during the lending period can be reduced. That is, in the second embodiment, the CPU 102 confirms whether or not a value obtained by multiplying the predicted fatigue Hⱼ of each joint 901 of the robot 900 by the factor of safety (FoS) is less than the threshold Tⱼ. Then, in a case where the predicted fatigue Hⱼ multiplied by the factor of safety (FoS) is lower than the threshold Tⱼ for all the joints 901, the CPU 102 adds the values of the respective joints 901 to obtain a total value Dᵢ for the robot 900. The CPU 102 performs the same calculation on all of a plurality of available robots 900, and sets, as the robot 900 to be lent, the robot 900 having the smallest total value Dᵢ among the plurality of available robots 900.

As described above, in the second embodiment, the CPU 102 calculates the total value Dᵢ for the robot 900 in which the value obtained by multiplying the predicted fatigue Hⱼ by the factor of safety (FoS) does not exceed the threshold Tⱼ, and determines and selects, as the robot 900 to be lent, the robot 900 having the smallest total value Dᵢ. As a result, it is possible to select the robot 900 that is least likely to require the maintenance at the scheduled lending destination.

In addition, other configurations, operations, and effects in the second embodiment described above are similar to those in the first embodiment, and thus a description thereof will be omitted.

### Third Embodiment

Next, a third embodiment partially modified from the first embodiment will be described with reference to FIG. 10. FIG. 10 is a block diagram schematically illustrating a robot management system according to the third embodiment. In the description of the third embodiment, the same reference numerals are used for the same parts as those of the first embodiment, and a description thereof will be omitted.

For example, there is a case where a maintenance plan for a robot 900 is made like a case where a lending period of the robot 900 is long and maintenance of the robot 900 is originally required during the lending period. Here, for example, after the start of operation of the robot 900, an operating time of the robot 900 per day and the lending period of the robot 900 may increase due to a change in an originally scheduled production plan, and a demand for increased production of products (articles). Then, it may be necessary to change the maintenance plan for the robot 900. In the third embodiment, a method described below is employed in such a case.

In a robot management system 1 according to the third embodiment, in addition to a management apparatus 201-1 of a first production line that is a lending destination, a management apparatus 201-2 of a second production line that is a scheduled lending destination is also communicably connected to an information processing apparatus 101 as illustrated in FIG. 10. Since configurations of the management apparatus 201-1 and the management apparatus 201-2 are similar to that of a management apparatus 201 described in the first embodiment, a description thereof will be omitted.

After a robot 900 is lent and starts operation, actual operation information is transmitted from the management apparatus 201-2 of the second production line to the information processing apparatus 101. That is, the information processing apparatus 101 acquires fatigue accumulated in the robot 900 operated on the second production line. The fatigue may be recorded in a robot information storage unit 166 and updated as cumulative fatigue as needed, for example. At this time, in a case where there is a difference from information assumed at a robot operation design stage, the information is overwritten and updated. For example, an apparatus operation rate, a takt time, a robot operation program (including a teaching point, a speed, and an acceleration), and the like correspond to such information.

Then, in a case where there is a difference between predicted fatigue that is predicted (assumed) based on a robot operation design and information regarding the fatigue transmitted from the management apparatus 201-2, a CPU 102 of the information processing apparatus 101 calculates the predicted fatigue again. Then, the CPU 102 notifies a designer of a prediction result. Specifically, for example, in a case where it is determined that there is a change in a maintenance timing or the number of times until the end of the lending period, the CPU 102 reports the change via a user interface unit 163 (a display 108 or the like), that is, notifies the designer of the prediction result. As a result, it is possible to propose a change in the maintenance plan.

In addition, for example, there is a case where a situation in which a change occurs in the originally scheduled maintenance plan cannot be accepted on a production line on which the robot 900 has already started operation. For example, a case where the preceding and subsequent production processes cannot be changed and a case where a maintenance date of the production line is set in advance are considered.

At this time, a changed plan for the operation of the robot 900, which can comply with the originally scheduled maintenance plan, is created using functions of an operation design unit 162 and a simulation unit 164. The creation of the changed plan for the operation of the robot means that the operation is changed to such an operation that reduces a load applied to a joint 901 whose predicted fatigue exceeds a threshold, and for example, a change (the teaching point, the speed, and the acceleration) in the robot operation program corresponds thereto. Such work of generating the changed plan for the operation may be performed fully automatically in the information processing apparatus 101, or the designer may manually perform the robot operation design according to a change in the predicted fatigue.

As described above, in the third embodiment, the information processing apparatus 101 acquires the actual operation information from the second production line on which the operation of the robot 900 has been started. Then, the information processing apparatus 101 updates the predicted fatigue of the operating robot 900 based on the actual operation information. As a result, the designer can investigate an influence thereof and take measures.

In addition, other configurations, operations, and effects in the third embodiment described above are similar to those in the first embodiment, and thus a description thereof will be omitted.

### Possibility of Other Embodiments

In the first to third embodiments described above, the robot 900 is an industrial robot as an example, but the robot 900 is not limited thereto. For example, a cleaning robot, a serving robot in a restaurant or the like, a transport robot that transports cargo, a delivery drone, a pet robot, a robot that performs other various types of work, and a mobile apparatus can be considered as the work apparatus that performs an operation related to work. That is, any work apparatus may be used as long as fatigue is accumulated at the use destination or the scheduled use destination. The industrial robot may be various robot arms such as a horizontal articulated robot arm, a parallel link robot arm, and an orthogonal robot.

In the first to third embodiments, the speed reducer 902 of the robot 900 has been described as an example of the mechanism unit, but the mechanism unit is not limited thereto. For example, any mechanism may be used as the mechanism unit, and fatigue thereof may be measured or predicted as long as the mechanism is used for a sensor, a link, a motor, or the like in the robot 900.

Furthermore, in the first to third embodiments, the calculation of the cumulative fatigue and the predicted fatigue for each of the plurality of joints of the robot 900 has been described. However, the present technology is not limited thereto, and for example, in a case where a load applied to a specific joint is large and the specific joint first requires maintenance due to high fatigue, the cumulative fatigue or the predicted fatigue of only the specific joint may be acquired or calculated. As a result, a processing amount in the information processing apparatus 101 can be reduced.

Furthermore, in the first to third embodiments, the description has been given on the assumption that the robot 900 is lent to one scheduled use destination (scheduled lending destination). However, the present technology is not limited thereto, and the predicted fatigue may be calculated for two or more scheduled use destinations, and the robots 900 to be used at the scheduled use destinations may be determined and selected based on the predicted fatigue. In other words, it is assumed that there is a second scheduled use destination in which an operation different from an operation in a first scheduled use destination is to be performed. In this case, first, the processing unit (CPU 102) calculates the second information regarding the predicted fatigue for the plurality of work apparatuses (robots 900) based on the cumulative fatigue and the predicted additional fatigue to be accumulated at the first scheduled use destination. Further, the processing unit calculates third information regarding the predicted fatigue based on the cumulative fatigue and the predicted additional fatigue to be accumulated at the second scheduled use destination. Then, the processing unit determines the work apparatus to be used at the first scheduled use destination and the work apparatus to be used at the second scheduled use destination from among the plurality of work apparatuses based on the second information and the third information. With such a configuration, it is possible to select and deploy the most suitable work apparatuses to a plurality of scheduled use destinations.

The present disclosure can also be implemented by a process in which a program for implementing one or more functions of the embodiments is supplied to a system or a device via a network or a storage medium, and one or more processors in a computer of the system or the device read and execute the program. The present disclosure can also be implemented by a circuit (for example, an application specific integrated circuit (ASIC)) that implements one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-023605, filed February 17, 2025, which is hereby incorporated by reference herein in its entirety.

What is claimed is:

1. An information processing method executed by a processing unit, the information processing method comprising:
acquiring first information regarding cumulative fatigue accumulated for each of a plurality of work apparatuses;
calculating second information regarding predicted fatigue for each of the plurality of work apparatuses based on the cumulative fatigue and predicted additional fatigue to be accumulated at a scheduled use destination; and
determining a work apparatus to be used at the scheduled use destination from among the plurality of work apparatuses based on a plurality of pieces of calculated second information.

2. The information processing method according to claim 1, wherein
each of the plurality of work apparatuses includes a mechanism unit configured to perform an operation,
the first information is information regarding the cumulative fatigue of the mechanism unit, and
the second information is information regarding the predicted fatigue of the mechanism unit.

3. The information processing method according to claim 2, wherein
each of the plurality of work apparatuses is an articulated robot including a plurality of joints each including the mechanism unit,
the first information is information regarding the cumulative fatigue managed for each of the plurality of joints, and
the second information is information regarding the predicted fatigue managed for each of the plurality of joints.

4. The information processing method according to claim 2, wherein
each of the plurality of work apparatuses is an articulated robot including a plurality of joints each including the mechanism unit,
the first information is information regarding the cumulative fatigue of a specific joint among the plurality of joints, and
the second information is information regarding the predicted fatigue of the specific joint.

5. The information processing method according to claim 1, wherein the predicted additional fatigue is information calculated based on operation setting information for setting an operation of the work apparatus at the scheduled use destination.

6. The information processing method according to claim 5, wherein
each of the work apparatuses is a robot including an arm, and
the operation setting information includes at least one of a teaching point, an operation speed, an acceleration, an end effector weight, a motor rotation speed, an operation cycle number, or an operation takt time.

7. The information processing method according to claim 1, further comprising:
calculating third information regarding the predicted fatigue for each of the plurality of work apparatuses based on the cumulative fatigue and the predicted additional fatigue to be accumulated at a second scheduled use destination, where the scheduled use destination is a first scheduled use destination, and the second scheduled use destination is a scheduled use destination in which an operation different from an operation in the first scheduled use destination is to be performed,
wherein the processing unit determines a work apparatus to be used at the first scheduled use destination and a work apparatus to be used at the second scheduled use destination from among the plurality of work apparatuses based on the second information and the third information.

8. The information processing method according to claim 1, further comprising:
calculating a difference between the predicted fatigue and a threshold for fatigue requiring maintenance based on the second information,
wherein the processing unit determines, as the work apparatus to be used at the scheduled use destination, a work apparatus having a smallest difference from among the plurality of work apparatuses.

9. The information processing method according to claim 1, further comprising:
calculating predicted safety-adjusted fatigue by multiplying the predicted fatigue by a factor of safety based on the second information,
wherein the processing unit determines, as the work apparatus to be used at the scheduled use destination, a work apparatus whose predicted safety-adjusted fatigue is lower than a threshold for fatigue requiring maintenance from among the plurality of work apparatuses.

10. The information processing method according to claim 8, further comprising:
acquiring actual operation information and updating the second information of the work apparatus after the work apparatus is actually operated at the scheduled use destination.

11. The information processing method according to claim 10, further comprising:
reporting a prediction result in a case where it is predicted that the predicted fatigue exceeds the threshold based on the updated second information after the work apparatus is actually operated at the scheduled use destination.

12. The information processing method according to claim 11, further comprising:
calculating operation setting information for setting an operation of the work apparatus for preventing the predicted fatigue from exceeding the threshold in a case where it is predicted that the predicted fatigue exceeds the threshold after the work apparatus is actually operated at the scheduled use destination.

13. The information processing method according to claim 1, wherein
the cumulative fatigue is cumulative fatigue accumulated at a use destination,
the use destination is a lending destination to which the work apparatus was lent, and
the scheduled use destination is a scheduled lending destination to which the work apparatus determined from among the plurality of work apparatuses is to be lent.

14. The information processing method according to claim 1, further comprising:
displaying images corresponding to the plurality of work apparatuses, and the plurality of pieces of first information and the plurality of pieces of second information in the plurality of work apparatuses on a display unit in association with each other.

15. The information processing method according to claim 1, further comprising:
displaying, on a display unit, a screen for previewing work to be performed at the scheduled use destination by a certain work apparatus among the plurality of work apparatuses.

16. The information processing method according to claim 1, further comprising:
collectively displaying, on a display unit, an image corresponding to a certain work apparatus among the plurality of work apparatuses, the first information and the second information of the certain work apparatus, a program for work to be performed by the certain work apparatus at the scheduled use destination, and a screen for previewing the work to be performed by the certain work apparatus at the scheduled use destination.

17. An information processing apparatus comprising:
a processing unit,
wherein the processing unit is configured to:
acquire first information regarding cumulative fatigue accumulated for each of a plurality of work apparatuses;
calculate second information regarding predicted fatigue for each of the plurality of work apparatuses based on the cumulative fatigue and predicted additional fatigue to be accumulated at a scheduled use destination; and
determine a work apparatus to be used at the scheduled use destination from among the plurality of work apparatuses based on a plurality of pieces of calculated second information.

18. A work apparatus management method comprising:
performing management to deploy a work apparatus determined by the information processing method according to claim 1 from among the plurality of work apparatuses to the scheduled use destination.

19. An article manufacturing method comprising:
deploying a work apparatus determined by the information processing method according to claim 1 to a production facility configured to manufacture an article, the production facility corresponding to the scheduled use destination; and
manufacturing the article by the deployed work apparatus.

20. A non-transitory computer-readable recording medium recording a program for causing a computer to execute the information processing method according to claim 1.
